(19) United States
(12) Patent Application Publication
(10) Pub. No.: US 2015/0215890 A1
(43) Pub. Date: Jul. 30, 2015

(54) WIRELESS TERMINAL DEVICE AND METHOD FOR OUTPUTTING LOCATION INFORMATION

(71) Applicant: FUJITSU LIMITED, Kawasaki-shi (JP)

(72) Inventor: Katsuo NAGATOMO, Hino (JP)

(21) Appl. No.: 14/546,774

(22) Filed: Nov. 18, 2014

(30) Foreign Application Priority Data
Jan. 27, 2014 (JP) 2014-012624

(51) Int. Cl. H04W 64/00

(52) U.S. Cl. CPC H04W 64/00

(57) ABSTRACT

A wireless terminal device includes a storage unit and a processor. The processor is configured to acquire identification information of a base station and acquire first and second location information indicating first and second locations of the wireless terminal device, respectively. The processor is configured to store the first and second location information acquired in a communication area of the captured base station during a preset period of time in the storage unit in association with the identification information of the captured base station. The processor is configured to acquire first identification information of a currently captured base station when a location request is detected. The processor is configured to output the first location information or the second location information stored in the storage unit in association with the first identification information.

### CROSS-REFERENCE TO RELATED APPLICATION

This application is based upon and claims the benefit of priority from the prior Japanese Patent Application No. 2014-012624 filed on Jan. 27, 2014, the entire contents of which are incorporated herein by reference.

### FIELD

The embodiments discussed herein are related to a wireless terminal device and a method for outputting location information.

### BACKGROUND

In recent years, wireless terminal devices, such as a smart phone and a tablet terminal, are equipped with a location acquisition function such as the global positioning system (GPS) for acquiring a current location of its own terminal. Further, an application or a service that utilizes the location acquisition function tends to increase in recent years.

When an application using the current location is run, the wireless terminal device uses, for example, the GPS to acquire the current location and provide the acquired current location to the application or the service server to achieve the application or the service.

Related techniques are disclosed in, for example, Japanese Laid-Open Patent Publication No. 2004-180204 and Japanese Laid-Open Patent Publication No. 2011-217095.

However, wireless terminal devices require large amounts of electrical power for the location acquisition function such as the GPS. Furthermore, since wireless terminal devices repeat a retrial operation when they are unable to acquire the current location by the location acquisition function, large amounts of electrical power is consumed.

### SUMMARY

According to an aspect of the present invention, provided is a wireless terminal device including a storage unit and a processor. The processor is configured to acquire identification information of a base station captured by a long-range wireless scheme. The processor is configured to acquire first location information indicating a first location of the wireless terminal device. The first location information is acquired in a first manner based on location information indicating a location of a relay station captured by a short-range wireless scheme. The processor is configured to acquire second location information indicating a second location of the wireless terminal device. The second location information is acquired in a second manner different from the first manner. The processor is configured to store the first location information acquired in a communication area of the captured base station during a preset period of time in the storage unit in association with the identification information of the captured base station. The processor is configured to store the second location information acquired in the communication area during the preset period of time in the storage unit in association with the identification information of the captured base station. The processor is configured to acquire first identification information of a currently captured base station when a location request is detected. The location request requests location information indicating a current location of the wireless terminal device. The processor is configured to output the first location information or the second location information stored in the storage unit in association with the first identification information.

The objects and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a wireless system according to an embodiment;

FIG. 2 is a diagram illustrating an example of a wireless terminal device;

FIG. 3 is a diagram illustrating an example of a location table;

FIG. 4 is a view illustrating an example of a manipulation screen of the wireless terminal device;

FIG. 5 is a flowchart illustrating an example of processing operations of a location learning process performed by a CPU of the wireless terminal device;

FIG. 6 is a flowchart illustrating an example of processing operations of a location information providing process performed by the CPU of the wireless terminal device;

FIG. 7 is a diagram illustrating another example of the location table; and

FIG. 8 is a diagram illustrating an example of the wireless terminal device.

### DESCRIPTION OF EMBODIMENTS

Hereinafter, descriptions will be made on embodiments of a wireless terminal device and a method for outputting location information in detail with reference to the drawings. Technologies are not limited to the embodiments. Respective embodiments described in the following may be appropriately combined within a range which does not cause contradiction.

### First Embodiment

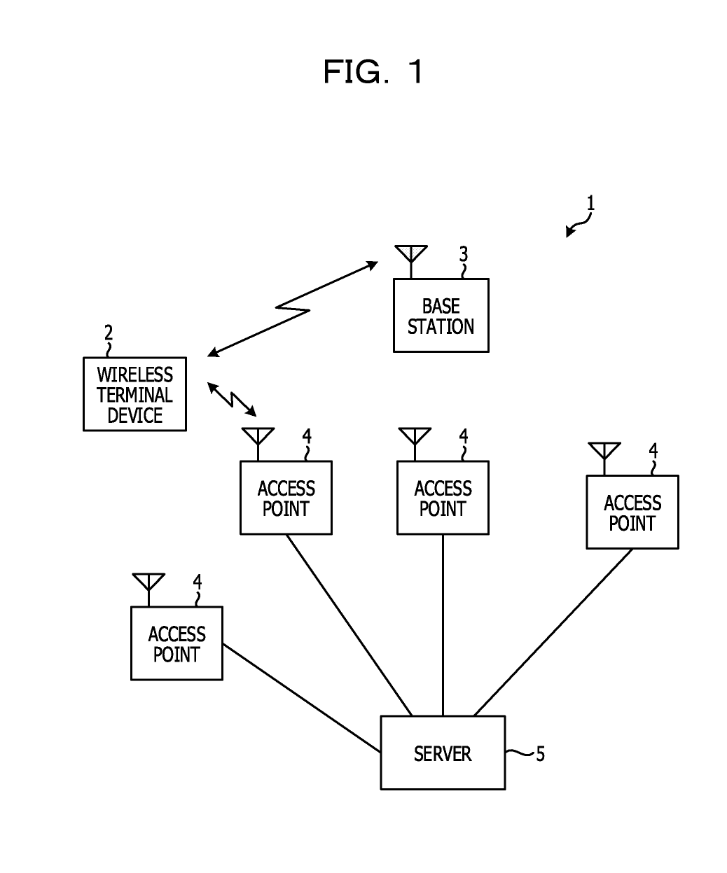

FIG. 1 is an explanatory view illustrating an example of a wireless system according to a first embodiment. The wireless system 1 illustrated in FIG. 1 includes a wireless terminal device 2, a base station 3, access points 4 and a server 5. The wireless terminal device 2 is a wireless terminal device, for example, a smart phone, a tablet terminal, or a mobile phone. The wireless terminal device 2 has a wireless communication function of a long-range wireless scheme such as the Long Term Evolution (LTE which is a registered trademark) scheme, a third generation (3G) scheme, or the global system for mobile communications (GSM which is a registered trademark) scheme. Further, the wireless terminal device 2 has a wireless communication function of a short-range wireless scheme such as the wireless local area network (WLAN) communication such as the Wireless Fidelity (Wi-Fi which is a registered trademark), a wireless communication according to the Near Field Communication (NFC) standard, or an infrared communication. Further, the wireless terminal device 2 has the GPS function and the like.

The base station 3 constitutes, for example, a wireless cell of the long-range wireless scheme to relay wireless communications of the wireless terminal device 2 in the wireless cell. Each access point 4 is a relay station which constitutes, for example, a wireless cell of WLAN which is the short-range wireless scheme to relay wireless communications of the wireless terminal device 2 in the wireless cell. The server 5 is a management apparatus such as a computer, which manages the location information of the access points 4. The server 5 is in a state of being communicable with the wireless terminal device 2 through the access points 4 or the base station 3.

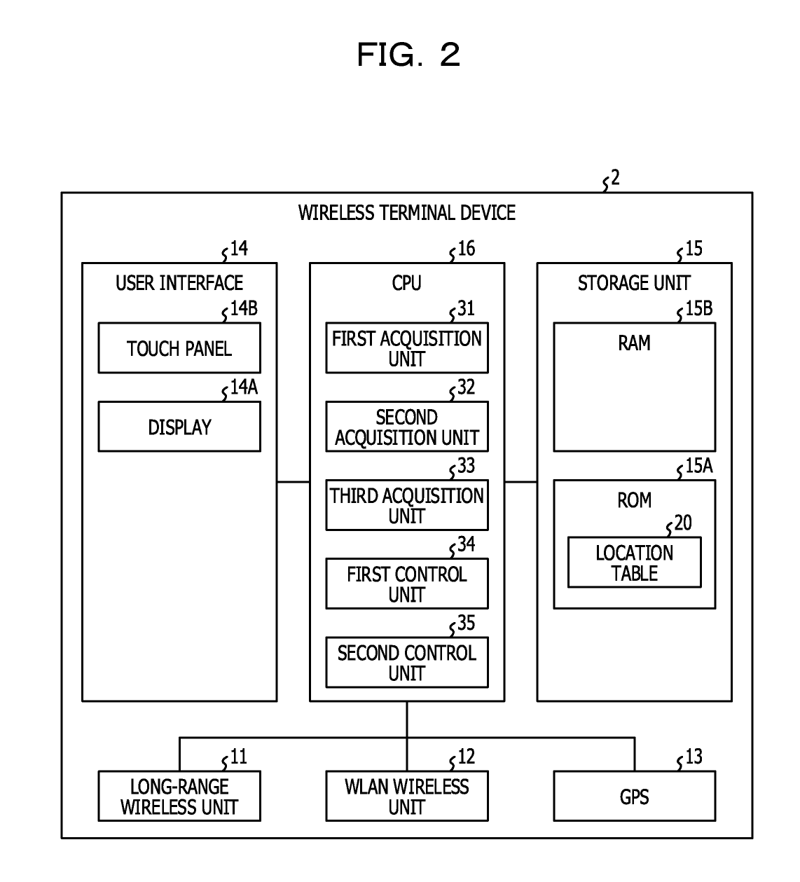

FIG. 2 is a diagram illustrating an example of the wireless terminal device 2. The wireless terminal device 2 illustrated in FIG. 2 includes a long-range wireless unit 11, a WLAN wireless unit 12, a GPS 13, a user interface 14, a storage unit 15 and a central processing unit (CPU) 16. The long-range wireless unit 11 is a communication interface which accesses, using the long-range wireless scheme, another wireless terminal device or the Internet through the base station 3. The long-range wireless unit 11 wirelessly communicates with the base station 3 captured by, for example, the scanning operation to acquire a base station identifier (ID) identifying the captured base station 3. Further, the long-range wireless unit 11 acquires a radio wave intensity of the wireless signal received from the captured base station 3.

The WLAN wireless unit 12 is a communication interface which accesses, for example, another wireless terminal device or the Internet through the access points 4 using the WLAN scheme. The WLAN wireless unit 12 scans, for example, beacon signal transmitted from the access points 4 and acquires a media access control (MAC) address or a service set identifier (SSID) which identifies a access point 4 captured by the scanning operation. Further, the WLAN wireless unit 12 acquires a radio wave intensity of the beacon signal received from the captured access point 4.

The GPS 13 simultaneously communicates with a GPS satellite and the base station 3, for example, to acquire a time information from the GPS satellite and a satellite orbit data from the base station 3 in order to acquire the GPS location information indicating the current location of the wireless terminal device 2 on the basis of the time information and the satellite orbit data.

The user interface 14 includes, for example, a display 14A and a touch panel 14B. The display 14A is an output interface which displays and outputs various pieces of information. The touch panel 14B is an input interface for designating a command on the display screen displayed on the display 14A and inputting the designated command

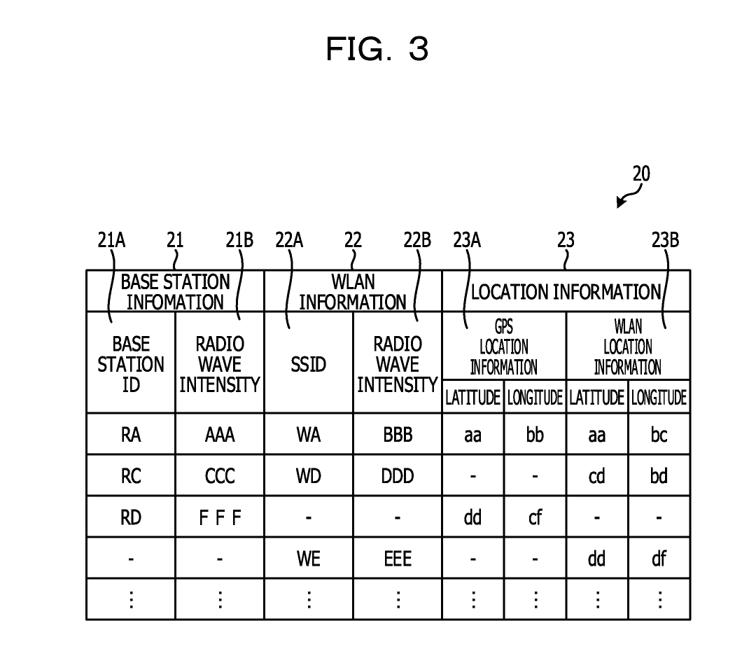

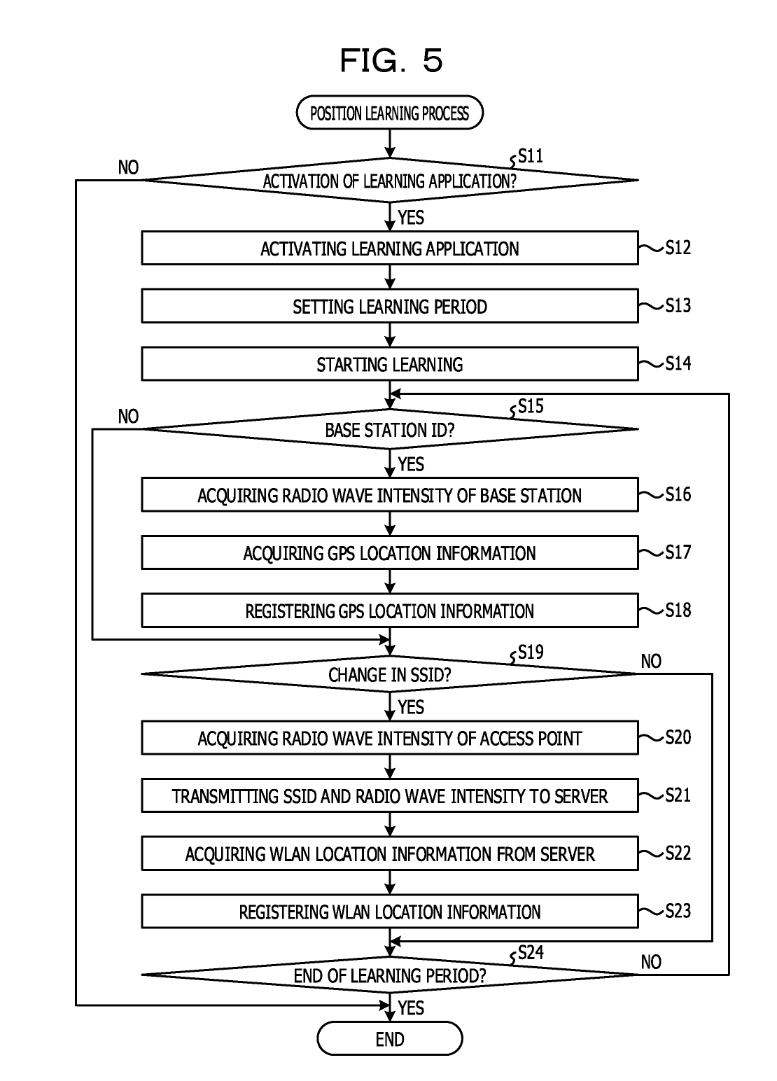

The storage unit 15 includes, for example, a read-only memory (ROM) 15A and a random access memory (RAM) 15B. The ROM 15A is an area storing information such as various programs. The RAM 15B is an area storing various information. The ROM 15A stores therein, for example, a location table 20. FIG. 3 is a diagram illustrating an example of the location table 20. The location table 20 illustrated in FIG. 3 associates base station information 21, WLAN information 22, and location information 23 with one another to be registered. The CPU 16 acquires the location information of the wireless terminal device 2 by the location learning process, which will be described later with reference to FIG. 5, and registers the acquired location information in the location table 20 for each piece of base station information 21 or each piece of WLAN information 22. The base station information 21 includes a base station ID 21A and a radio wave intensity 21B. The base station ID 21A is, for example, an ID which identifies the base station 3 captured by the scanning operation of the wireless terminal device 2. The radio wave intensity 21B is the radio wave intensity of the wireless signal transmitted between the wireless terminal device 2 and the base station 3 captured by the scanning operation of the wireless terminal device 2. The WLAN information 22 includes a SSID 22A and a radio wave intensity 22B. The SSID 22A is, for example, an ID which identifies the access point 4 captured by the scanning operation of the wireless terminal device 2. The radio wave intensity 22B is the radio wave intensity of the wireless signal transmitted between the wireless terminal device 2 and the access point 4 captured by the scanning operation of the wireless terminal device 2. The location information 23 includes GPS location information 23A and WLAN location information 23B. The GPS location information 23A is location information (latitude and longitude) acquired by the GPS 13 and indicates the current location of the wireless terminal device 2. The WLAN location information 23B is the location information (latitude and longitude) calculated on the basis of the location information and the radio wave intensity of the captured access point 4 and indicates the current location of the wireless terminal device 2. The server 5 calculates the WLAN location information indicating the current location of the wireless terminal device 2 on the basis of the radio wave intensity obtained from the wireless terminal device 2 and the location information of an access point 4 associated with the SSID obtained from the wireless terminal device 2, and provides the calculated WLAN location information to the wireless terminal device 2.

The CPU 16 controls the entirety of the wireless terminal device 2. The CPU 16 reads out an application program for outputting the location information from the ROM 15A, and performs processes of the first acquisition unit 31, the second acquisition unit 32, the third acquisition unit 33, the first control unit 34 and the second control unit 35 in accordance with the read-out application program for outputting the location information. The first acquisition unit 31 acquires the base station ID and the radio wave intensity of the base station 3 captured through the long-range wireless unit 11. The second acquisition unit 32 acquires the SSID and the radio wave intensity of the access point 4 captured through the WLAN wireless unit 12. Further, the second acquisition unit 32 notifies the server 5 of the SSID and the radio wave intensity through the WLAN wireless unit 12 or the long-range wireless unit 11, and also acquires the WLAN location information indicating the current location of the wireless terminal device 2 from the server 5. The third acquisition unit 33 acquires the GPS location information indicating the current location of the wireless terminal device 2 from the GPS 13.

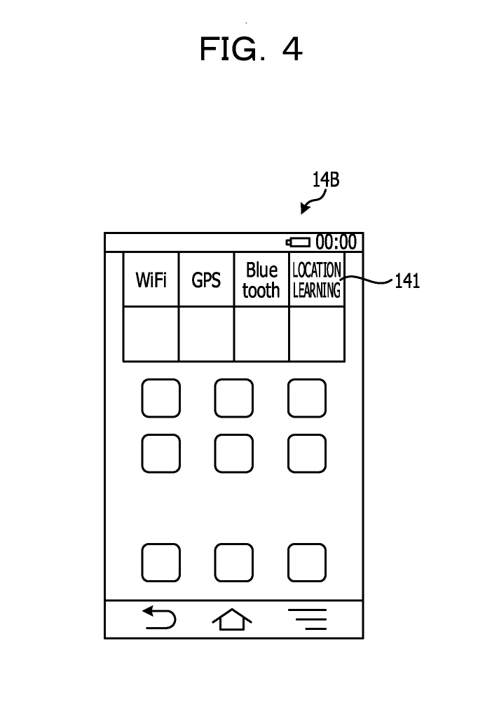

The first control unit 34 performs the location learning process illustrated in FIG. 5 to be described later. The location learning process is a process for sequentially acquiring the location information of the wireless terminal device 2 within a preset learning period in response to, for example, an activation manipulation of a location learning button 141 on the touch panel 14B illustrated in FIG. 4, and registers the acquired location information in the location table 20. FIG. 4 is an explanatory view illustrating an example of a manipulation screen of the wireless terminal device 2. The learning period may be appropriately set or changed, and may be set to, for example, a period of three days.

The first control unit 34 acquires a base station ID of the base station 3 captured by the first acquisition unit 31 during the learning period. The first control unit 34 also acquires the GPS location information by the third acquisition unit 33 when the base station ID acquired at this time is different from the base station ID acquired at previous time, that is, when there is a change in the base station ID. When the GPS location information is acquired, the first control unit 34 registers the GPS location information in a field of the location table 20 corresponding to the base station ID acquired at this time.

Even when there is no change in the base station ID during the learning period, the first control unit 34 acquires the SSID and the radio wave intensity of the access point 4 captured by the second acquisition unit 32. When the SSID acquired at this time is different from the SSID acquired at previous time, that is, when there is a change in the SSID, the first control unit 34 acquires the WLAN location information through the second acquisition unit 32. When the WLAN location information is acquired, the first control unit 34 registers the WLAN location information in a field of the location table 20 corresponding to the SSID acquired at this time.

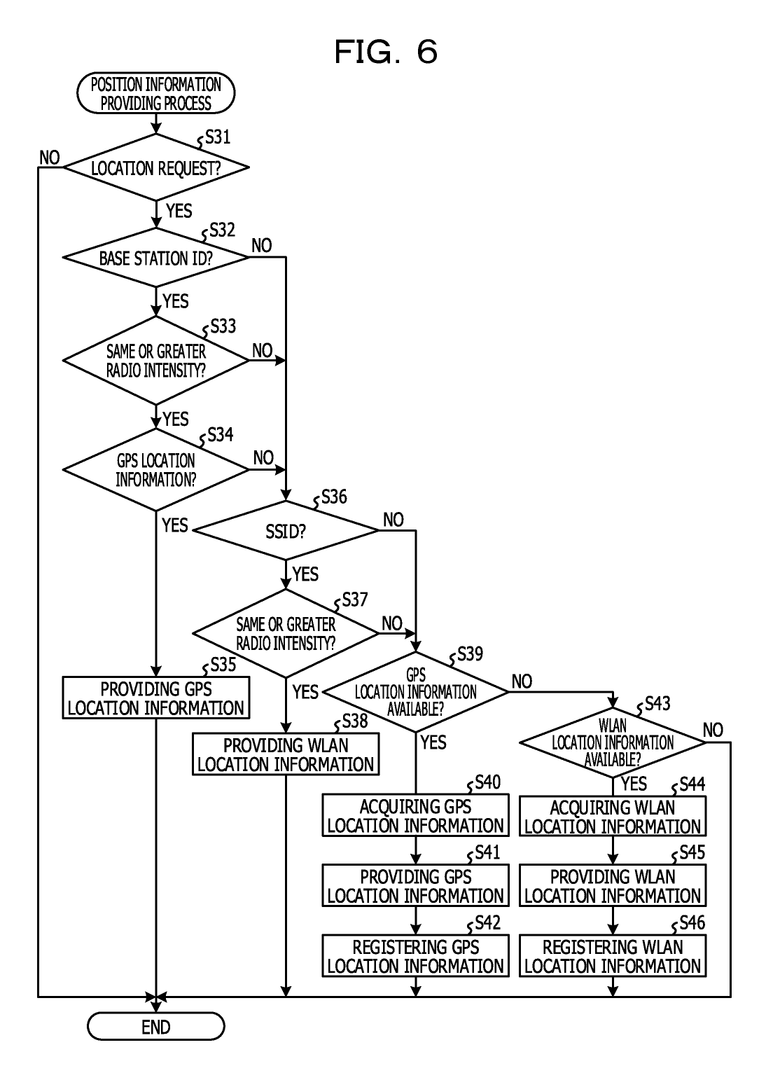

The second control unit 35 performs a location information providing process illustrated in FIG. 6 to be described later. The location information providing process is a process for providing the location information of the wireless terminal device 2, which is stored in the location table 20, to a request source of a location request requesting location information indicating the current location of the wireless terminal device 2 when the location request is detected. When the location request is detected, the second control unit 35 determines whether the current base station ID of the captured base station is present in the location table 20. When the current base station ID of the captured base station is present in the location table 20, the second control unit 35 provides the GPS location information associated with the current base station ID to the source of the location request. The request source is a source which transmits the location request and corresponds to, for example, an application run by the CPU 16 or a service server. When the request source is an application, the second control unit 35 provides the GPS location information to the application. When the request source is a service server, the second control unit 35 provides the GPS location information to the service server through the long-range wireless unit 11 or the WLAN wireless unit 12. When the current base station ID is not present in the location table 20, the second control unit 35 determines whether the current SSID of the captured access point is present in the location table 20. When the current SSID is present in the location table 20, the second control unit 35 provides the WLAN location information associated with the current SSID to the request source.

Here, a specific example of the location learning process and the location information providing process described above will be described. For example, many users who commute from their residences to offices (schools) tend to use nearly the same route for commuting to office (route for commuting to school) and also frequently utilize an application using a GPS function on the same route. Accordingly, an electric power is heavily consumed by the GPS 13 if the GPS 13 is executed each time the application is utilized on the same route. Therefore, in the location learning process, the location information of the wireless terminal device 2 at a point where the base station ID is changed and a point where the SSID is changed on the same route is registered in the location table 20 during the learning period. Also, in the location information providing process, when the location request from, for example, an application is detected, the base station ID of the captured base station 3 or the SSID of the access point 4 is acquired. Further, in the location information providing process, the location information associated with the base station ID or the SSID is acquired from the location table 20 and the acquired location information is provided to the application described above. As a result, the use frequency of the GPS 13 or the WLAN wireless unit 12 after the learning period has elapsed may be suppressed and the power consumption by the GPS 13 or the WLAN wireless unit 12 may be suppressed to achieve power saving for the entire wireless terminal device 2.

Next, descriptions will be made on the operation of the wireless system 1 according to the present embodiment. FIG. 5 is a flowchart illustrating an example of processing operations of the location learning process performed by the CPU 16 of the wireless terminal device 2. In FIG. 5, the CPU 16 determines whether a tap manipulation of the location learning button 141 on the touch panel 14B illustrated in FIG. 4 is detected, that is, an activation manipulation of the learning application is detected (S11). When it is determined that the activation manipulation of the learning application is detected (“YES” at S11), the CPU 16 activates the learning application (S12). The CPU 16 sets a learning period after activating the learning application (S13) and starts a learning operation (S14). The learning period may be appropriately changed according to the setting manipulation of a user.

After the learning operation is started, the first acquisition unit 31 of the CPU 16 determines whether a change in the base station ID is detected through the long-range wireless unit 11 (S15). When it is determined that a change in the base station ID is detected (“YES” at S15), the first control unit 34 of the CPU 16 acquires the radio wave intensity of the base station 3 associated with the current base station ID, and registers the acquired radio wave intensity and the base station ID in the location table 20 (S16). The third acquisition unit 33 of the CPU 16 activates the GPS 13 and acquires the GPS location information of the wireless terminal device 2 (S17). After the GPS location information is acquired, the first control unit 34 ends the operation of the GPS 13 and registers the acquired GPS location information in a field of the location table 20 corresponding to the base station ID (S18).

Further, the second acquisition unit 32 of the CPU 16 determines whether a change in the SSID is detected (S19). When it is determined that a change in the SSID is detected (“YES” at S19), the first control unit 34 acquires the radio wave intensity of the access point 4 associated with the current SSID, and registers the acquired radio wave intensity in a field of the location table 20 corresponding to the SSID (S20). The second acquisition unit 32 transmits the acquired SSID and the radio wave intensity to the server 5 (S21). The server 5 calculates the WLAN location information indicating the current location of the wireless terminal device 2 on the basis of the acquired radio wave intensity and the location information of the access point 4 associated with the acquired SSID.

The first control unit 34 acquires the WLAN location information from the server 5 through the second acquisition unit 32 (S22), and registers the acquired WLAN location information in a field of the location table 20 corresponding to the SSID (S23). The CPU 16 determines whether the learning period is ended (S24). When it is determined that the learning period is ended (“YES” at S24), the CPU 16 ends the processing operations illustrated in FIG. 5.

When it is determined that the learning period is not ended (“NO” at S24), the CPU 16 proceeds to S15 to determine whether a change in the base station ID is detected. When it is determined that a change in the base station ID is not detected (“NO” at S15), the CPU 16 proceeds to S19 to determine whether a change in the SSID is detected.

When it is determined that the change in the SSID is not detected (“NO” at S19), the CPU 16 proceeds to S24 to determine whether the learning period is ended. When it is determined that the activation manipulation of the learning application is not detected (“NO” at S11), the CPU 16 ends the processing operations illustrated in FIG. 5.

When a change in the base station ID is detected during the learning period, the CPU 16 performing the location learning process illustrated in FIG. 5 acquires the GPS location information through the third acquisition unit 33 using the GPS 13, and associates the GPS location information with the current base station ID to be registered in the location table 20. As a result, it is possible to learn the GPS location information of the wireless terminal device 2 at a point where the base station ID is changed during the learning period. For example, when the wireless terminal device 2 moves along the route for commuting to office during the learning period, it is possible to learn the GPS location information of the wireless terminal device 2 at the point where the base station ID is changed on the route for commuting to office.

When a change in the SSID is detected during the learning period, the CPU 16 acquires the WLAN location information through the second acquisition unit on the basis of the location information and the radio wave intensity of the captured access point 4, and associates the acquired WLAN location information with the current SSID to be registered in the location table 20. As a result, it is possible to learn the WLAN location information of the wireless terminal device 2 at a point where the SSID is changed during the learning period. For example, when the wireless terminal device 2 moves along the route for commuting to office during the learning period, it is possible to learn the GPS location information of the wireless terminal device 2 at the point where the SSID is changed on the route for commuting to office.

FIG. 6 is a flowchart illustrating an example of processing operations of the location information providing process performed by the CPU 16 of the wireless terminal device 2. In FIG. 6, the second control unit 35 of the CPU 16 determines whether a location request which requests location information indicating the current location is detected (S31). When it is determined that the location request is detected (“YES” at S31), the second control unit 35 determines whether the base station ID of the currently captured base station 3 is present in the location table 20 (S32).

When it is determined that the current base station ID is present in the location table 20 (“YES” at S32), the second control unit 35 determines whether the radio wave intensity of the currently captured base station 3 is equal to or greater than the radio wave intensity associated with the base station ID which has been registered in the location table 20 (S33). The process of determining whether the current radio wave intensity is equal to or greater than the radio wave intensity associated with the base station ID which has been registered determines that the current radio wave intensity is equal to or greater than the radio wave intensity, in a case where a difference between the current radio wave intensity and the radio wave intensity which has been registered falls within a threshold value or the current radio wave intensity is greater than the radio wave intensity which has been registered.

When it is determined that the current radio wave intensity is equal to or greater than the radio wave intensity associated with the base station ID which has been registered (“YES” at S33), the second control unit 35 determines whether the GPS location information associated with the current base station ID is present in the location table 20 (S34).

When it is determined that the GPS location information associated with the current base station ID is present in the location table 20 (“YES” at S34), the second control unit 35 acquires the GPS location information associated with the current base station ID from the location table 20 and provides the acquired GPS location information to the request source of the location request (S35). Thereafter, the second control unit 35 ends the processing operations illustrated in FIG. 6.

When it is determined that the location request is not detected (“NO” at S31), the second control unit 35 ends the processing operations illustrated in FIG. 6. When it is determined that the current base station ID is not present in the location table 20 (“NO” at S32), the second control unit 35 determines whether the current SSID is present in the location table 20 (S36). When it is determined that the current SSID is present in the location table 20 (“YES” at S36), the second control unit 35 determines whether the radio wave intensity of the currently captured access point 4 is equal to or greater than the radio wave intensity associated with the SSID which has been registered in the location table 20 (S37).

When it is determined that the current radio wave intensity is equal to or greater than the radio wave intensity associated with the SSID which has been registered (“YES” at S37), the second control unit 35 acquires the WLAN location information associated with the current SSID from the location table 20, and provides the acquired WLAN location information to the request source of the location request (S38). Thereafter, the second control unit 35 ends the processing operations illustrated in FIG. 6.

When it is determined that the current SSID is not present in the location table 20 (“NO” at S36), the third acquisition unit 33 of the CPU 16 determines whether the current GPS location information is available (S39). Whether the current GPS location information is available is determined by determining whether the GPS location information may be acquired by using the GPS 13. When it is determined that the current GPS location information is available (“YES” at S39), the CPU 16 activates the GPS 13 and acquires the GPS location information through the third acquisition unit 33. The CPU 16 also acquires radio wave intensity through the first acquisition unit 31 (S40). The third acquisition unit 33 ends the operation of the GPS 13 after the GPS location information is acquired. The second control unit 35 provides the GPS location information acquired through the third acquisition unit 33 to the request source of the location request (S41). The second control unit 35 associates the GPS location information acquired through the third acquisition unit 33 and the radio wave intensity acquired through the first acquisition unit 31 with the current base station ID to be registered in the location table 20 (S42), and ends the processing operations illustrated in FIG. 6.

When it is determined that the current GPS location information is not available (“NO” at S39), the second acquisition unit 32 determines whether the current WLAN location information is available (S43). Whether the current WLAN location information is available is determined by determining whether the SSID and the radio wave intensity may be acquired through the WLAN wireless unit 12 and whether the WLAN location information may be acquired from the server 5. When it is determined that the current WLAN location information is available (“YES” at S43), the second acquisition unit 32 acquires the WLAN location information and the radio wave intensity (S44). The second control unit 35 provides the WLAN location information acquired through the second acquisition unit 32 to the request source of the location request (S45). The second control unit 35 associates the WLAN location information and the radio wave intensity acquired through the second acquisition unit 32 with the current SSID to be registered in the location table 20 (S46), and ends the processing operations illustrated in FIG. 6.

When it is determined that the current radio wave intensity is not equal to or greater than the radio wave intensity associated with the base station ID which has been registered in the location table (“NO” at S33), the second control unit 35 proceeds to S36 to determine whether the SSID is present in the location table 20. When it is determined that the GPS location information associated with the current base station ID is not present in the location table 20 (“NO” at S34), the second control unit 35 proceeds to S36 to determine whether the SSID is present in the location table 20.

When it is determined that the current radio wave intensity is not equal to or greater than the radio wave intensity associated with the SSID which has been registered in the location table (“NO” at S37), the second control unit 35 proceeds to S39 to determine whether the current GPS location information is available.

When the current WLAN location information is not available (“NO” at S43), the second acquisition unit 32 ends the processing operations illustrated in FIG. 6.

As illustrated in FIG. 6, when the location request is detected, the CPU 16 performing the location information providing process acquires the base station ID of the currently captured base station 3 and provides the GPS location information to the request source in a case where the GPS location information associated with the current base station ID is present in the location table 20. As a result, since the GPS location information associated with the current base station ID which has been registered in the location table 20 is provided to the request source without activating the GPS 13, the power consumption by the GPS 13 or the WLAN wireless unit 12 may be suppressed. Further, when the location information of the wireless terminal device 2 is provided on the route along which a user moves to commute to office during the learning period, the power consumption by the GPS 13 or the WLAN wireless unit 12 may be suppressed.

When the location request is detected, the CPU 16 acquires the SSID of the currently captured access point 4 in a case where the base station ID is not present in the location table 20. In a case where the WLAN location information associated with the current SSID is present in the location table 20, the CPU 16 provides the WLAN location information to the request source. As a result, since the WLAN location information associated with the current SSID which has been registered in the location table 20 is provided to the request source without activating the GPS 13, the power consumption by the GPS 13 or the WLAN wireless unit 12 may be suppressed. Further, when the location information of the wireless terminal device 2 is provided on the route along which a user moves to commute to office during the learning period, the power consumption by the GPS 13 or the WLAN wireless unit 12 may be suppressed.

The CPU 16 acquires the SSID of the currently captured access point 4 in a case where the GPS location information associated with the current base station ID is not present in the location table 20. In a case where the WLAN location information associated with the current SSID is present in the location table 20, the CPU 16 provides the WLAN location information to the request source. As a result, since the WLAN location information associated with the current SSID which has been registered in the location table 20 is provided to the request source without activating the GPS 13, the power consumption by the GPS 13 or the WLAN wireless unit 12 may be suppressed. Further, when the location information of the wireless terminal device 2 is provided on the route along which a user moves to commute to office during the learning period, the power consumption by the GPS 13 or the WLAN wireless unit 12 may be suppressed.

In a case where the current base station ID and the current SSID are not present in the location table 20 and the current GPS location information is available, the CPU 16 acquires the GPS location information and provides the acquired GPS location information to the request source. As a result, the GPS location information may be provided to the request source. Further, the CPU 16 may associate the acquired GPS location information with the current base station ID to be registered additionally in the location table 20.

In a case where the current base station ID and SSID are not present in the location table 20, the current GPS location information is not available, and the current WLAN location information is available, the CPU 16 acquires the WLAN location information and provides the acquired WLAN location information to the request source. As a result, the WLAN location information may be provided to the request source. Further, the CPU 16 may associate the acquired WLAN location information with the current SSID to be registered additionally in the location table 20.

In the embodiment, during the learning period, the GPS location information is registered in the location table 20 for each point where the base station ID is changed on a movement route and the WLAN location information is registered in the location table 20 for each point where the SSID is changed on the movement route. As a result, it is possible to manage in the location table 20 the GPS location information and the WLAN location information of the wireless terminal device 2 at the points where the base station ID is changed and the WLAN location information is changed on the movement route during the learning period.

According to the present embodiment, when a location request is detected, the GPS location information associated with the current base station ID is acquired from the location table 20 and the acquired GPS location information is provided to the request source. As a result, when the location request is detected on the same movement route as that learned during the learning period, since the wireless terminal device 2 is able to provide the GPS location information to the request source without activating the GPS 13, the power consumption needed for a location acquisition operation of, such as the GPS 13 may be suppressed. That is, by suppressing the frequency of the location acquisition operation after the learning period has elapsed, the power consumption needed for the location acquisition operation is suppressed, so that it is possible to achieve power saving for the entire wireless terminal device 2.

In the embodiment, when the location request is detected and the GPS location information associated with the current base station ID is not present in the location table 20, the WLAN location information associated with the current SSID is acquired from the location table 20 and the acquired WLAN location information is provided to the request source. As a result, when the location request is detected on the same movement route as that learned during the learning period, the wireless terminal device 2 is able to provide the WLAN location information to the request source without activating the GPS 13 and the WLAN wireless unit 12. Therefore, by suppressing the frequency of the location acquisition operation of the GPS 13 and the like, the power consumption needed for location acquisition operation is suppressed, so that it is possible to achieve power saving for the entire wireless terminal device 2.

According to the present embodiments, in a case where both the GPS location information associated with the base station ID and the WLAN location information associated with the SSID are present in the location table 20, the GPS location information is provided to the request source. However, the WLAN location information may be provided to the request source.

According to the present embodiment, the base station information 21, the WLAN information 22, the GPS location information 23A and the WLAN location information 23B are associated with one another to be stored in the location table 20 as illustrated in FIG. 3. Then, the second control unit 35 determines whether the GPS location information 23A is present in the location table 20 at S34 of FIG. 6. When the GPS location information 23A is present in the location table 20, the second control unit 35 provides the GPS location information 23A to the request source.

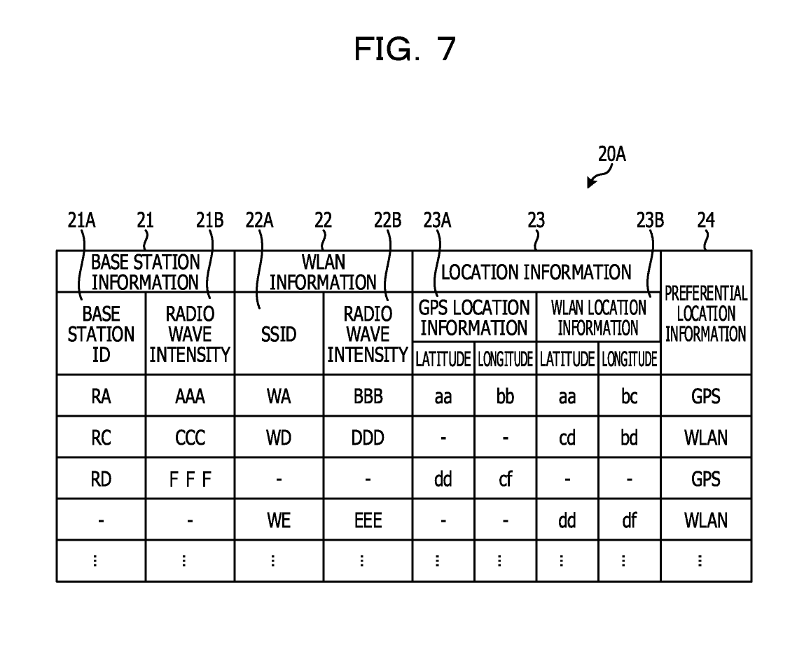

However, in addition to the base station information 21, the WLAN information 22, the GPS location information 23A and the WLAN location information 23B, preferential location information 24 indicating the location information to be preferentially provided to the request source may be associated with the base station ID to be stored in a location table 20A. FIG. 7 is a diagram illustrating an example of the location table 20A. In this case, when both the GPS location information 23A and the WLAN location information 23B are present in the location table 20A in association with the same base station ID 21A, the second control unit 35 refers to the preferential location information 24. The second control unit 35 outputs any one of the GPS location information 23A or the WLAN location information 23B as the location information 23 on the basis of the referred result of the preferential location information 24. For example, when the preferential location information 24 is the “GPS”, the second control unit 35 provides the GPS location information 23A from the location table 20A to the request source. When the preferential location information 24 is the “WLAN”, the second control unit 35 provides the WLAN location information 23B from the location table 20A to the request source. As a result, the second control unit 35 simply refers to the preferential location information 24 in the location table 20A to be able to recognize that any one of the GPS location information 23A or the WLAN location information 23B of the location information 23 to be provided and output.

The present embodiment is useful not only for the wireless terminal device 2 of a user who frequently moves on the same route but also for a case where the user moves in the vicinity of the same route.

According to the present embodiment, the WLAN is exemplified as the short-range wireless scheme, but the short-range wireless scheme is not limited to the WLAN but may include, for example, the NFC, as long as the short-range wireless scheme by which the current location of the wireless terminal device 2 may be acquired on the basis of the location information of the access point.

According to the present embodiment, the location information is acquired when the change in the base station ID or the SSID is detected, but the location information may be acquired at a predetermined time interval, for example, ten minutes interval. Alternatively, the location information may be acquired only when the change in both the station ID and the SSID are detected.

In the location learning process of FIG. 5, the location learning process is ended at the time when it is determined that the preset learning period is ended at S24, but the location learning process may be ended at a time of any manipulation during the learning period. In the location learning process, the GPS 13 is activated only when the GPS location information is to be acquired, but the GPS 13 may be continuously kept in an ON state only during the learning period.

In the location information providing process of FIG. 6, the determination processing of S33 is prepared, but the determination processing of S33 may be omitted and when it is determined that the current base station ID is present in the location table 20 at S32, the determination processing of S34 may be executed.

In the location information providing process of FIG. 6, the determination processing of S37 is prepared, but the determination processing of S37 may be omitted and when it is determined that the current SSID is present in the location table 20 at S36, the processing of S38 may be executed.

Respective constitutional elements of respective unit illustrated in the drawings are not necessarily configured the same as its physical configuration illustrated. That is, a specific mode of distribution and integration of the respective units is not limited to a mode illustrated and all or some of the units may be configured to be functionally and physically distributed and integrated in a certain unit according to various loads or use situation.

All or some of various processing functions performed by each device may be performed by a CPU or a micro-computer such as micro processing unit (MPU) or micro controller unit (MCU) by executing a program or by wired-logic hardware.

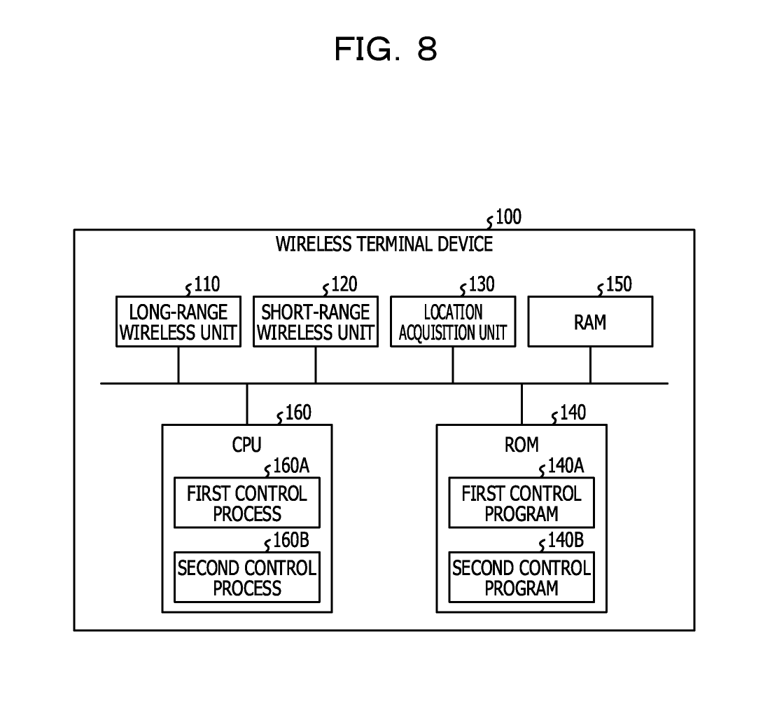

Various processes described in the present embodiment may be implemented by causing a processor such as the CPU included in the wireless terminal device to execute the program prepared in advance. Therefore, in the following description, an example of the wireless terminal device will be described, which executes the program for the same functions as the embodiment described above. FIG. 8 is a diagram illustrating an example of the wireless terminal device that executes the program for outputting location information.

As illustrated in FIG. 8, a wireless terminal device 100 that executes the program for outputting location information includes a long-range wireless unit 110, a short-range wireless unit 120, a location acquisition unit 130, a ROM 140, a RAM 150, and a CPU 160. The long-range wireless unit 110, the short-range wireless unit 120, the location acquisition unit 130, the ROM 140, the RAM 150, and the CPU 160 are connected with one another through a bus. The long-range wireless unit 110 acquires the identification information of the base station captured by the long-range wireless scheme. The short-range wireless unit 120 acquires the first location information indicating the current location of the wireless terminal device 100 obtained on the basis of the location information of the relay station captured by the short-range wireless scheme. The location acquisition unit 130 acquires the second location information indicating the current location of the wireless terminal device 100 by an information obtaining method different from that of the short-range wireless unit 120.

The program for outputting location information, which achieves the same function as the first embodiment described above, is stored in the ROM 140 in advance. A first control program 140A and a second control program 140B, which serve as the program for outputting location information, are stored in the ROM 140. Alternatively, the program for outputting location information may be stored in a computer-readable recording medium read by a drive (not illustrated). As for the recording medium, for example, a portable recording medium such as a compact disc read-only memory (CD-ROM), a digital versatile disc (DVD), or a universal serial bus (USB) memory and a semiconductor memory such as a flash memory may be used.

The CPU 160 reads and executes the first control program 140A from the ROM 140 to function as a first control process 160A which corresponds to the first control unit 34. Further, the CPU 160 reads and executes the second control program 140B from the ROM 140 to function as a second control process 160B which corresponds to the second control unit 35.

The CPU 160 acquires the first location information or the second location information in a communication area of the base station captured during a preset period of time and associates the first location information or the second location information to the identification information of the captured base station to be stored in the RAM 150. When the location request is detected, the CPU 160 acquires the identification information of the currently captured base station and outputs the first location information or the second location information associated with the identification information of the currently captured base station from the RAM 150. As a result, electric power saving may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless terminal device, comprising:
a storage unit; and
a processor configured to
acquire identification information of a base station captured by a long-range wireless scheme,
acquire first location information indicating a first location of the wireless terminal device, the first location information being acquired in a first manner based on location information indicating a location of a relay station captured by a short-range wireless scheme,
acquire second location information indicating a second location of the wireless terminal device, the second location information being acquired in a second manner different from the first manner,
store the first location information acquired in a communication area of the captured base station during a preset period of time in the storage unit in association with the identification information of the captured base station,
store the second location information acquired in the communication area during the preset period of time in the storage unit in association with the identification information of the captured base station,
acquire first identification information of a currently captured base station when a location request is detected, the location request requesting location information indicating a current location of the wireless terminal device, and
output the first location information or the second location information stored in the storage unit in association with the first identification information.

2. The wireless terminal device according to claim 1, wherein
the processor is configured to
output the second location information associated with the first identification information when both of the first location information and the second location information are stored in the storage unit in association with the first identification information.

3. The wireless terminal device according to claim 1, wherein
the processor is configured to
acquire identification information of the captured relay station,
store the first location information acquired in a communication area of the captured relay station during the preset period of time in the storage unit in association with the identification information of the captured relay station,
acquire, when the location request is detected and the first identification information is not stored in the storage unit, second identification information of a currently captured relay station, and
output the first location information stored in the storage unit in association with the second identification information.

4. A method for outputting location information, the method comprising:
acquiring, by a wireless terminal device, identification information of a base station captured by a long-range wireless scheme;
acquiring first location information indicating a first location of the wireless terminal device, the first location information being acquired in a first manner based on location information indicating a location of a relay station captured by a short-range wireless scheme;
acquiring second location information indicating a second location of the wireless terminal device, the second location information being acquired in a second manner different from the first manner;
storing the first location information acquired in a communication area of the captured base station during a preset period of time in a storage unit in association with the identification information of the captured base station;
storing the second location information acquired in the communication area during the preset period of time in the storage unit in association with the identification information of the captured base station;
acquiring first identification information of a currently captured base station when a location request is detected, the location request requesting location information indicating a current location of the wireless terminal device; and
outputting the first location information or the second location information stored in the storage unit in association with the first identification information.

5. A computer-readable recording medium having stored therein a program for causing a computer to execute a process, the process comprising:
acquiring identification information of a base station captured by a long-range wireless scheme;
acquiring first location information indicating a first location of the computer, the first location information being acquired in a first manner based on location information indicating a location of a relay station captured by a short-range wireless scheme;
acquiring second location information indicating a second location of the computer, the second location information being acquired in a second manner different from the first manner;
storing the first location information acquired in a communication area of the captured base station during a preset period of time in a storage unit in association with the identification information of the captured base station;
storing the second location information acquired in the communication area during the preset period of time in the storage unit in association with the identification information of the captured base station;
acquiring first identification information of a currently captured base station when a location request is detected, the location request requesting location information indicating a current location of the computer; and
outputting the first location information or the second location information stored in the storage unit in association with the first identification information.
